(19) United States
(12) Patent Application Publication
(10) Pub. No.: US 2010/0254319 A1
(43) Pub. Date: Oct. 7, 2010

(54) JOINT RESOURCE MANAGEMENT IN A FEMTOCELL NETWORK

(76) Inventors: Jeyhan Karaoguz, Irvine, CA (US); Charles Abraham, Los Gatos, CA (US); Xuemin Sherman Chen, Rancho Santa Fe, CA (US); Wael William Diab, San Francisco, CA (US); Vinko Erceg, Cardiff, CA (US); Victor T. Hou, La Jolla, CA (US); Mark Kent, Vista, CA (US)

Correspondence Address: MCANDREWS HELD & MALLOY, LTD, 500 WEST MADISON STREET, SUITE 3400, CHICAGO, IL, 60661, US

(21) Appl. No.: 12/418,360

(22) Filed: Apr. 3, 2009

(51) Int. Cl. H04W 72/04

(52) U.S. Cl. 370/329

(57) ABSTRACT

A Femtocell gateway is operable to determine resource usage information among associated Femtocells in a Femtocell network. The Femtocell gateway may be enabled to allocate resources for distributing traffic among the associated Femtocells based on the determined resource usage information comprising IP usage information, radio access usage, and/or physical layer capabilities among the Femtocells. The Femtocell gateway may be enabled to identify Femtocells with excess resources assigned and Femtocells with a need for additional resources to support a particular traffic based on the determined resource usage information. The Femtocell gateway is operable to allocate and/or reallocate at least a portion of excess resources to the Femtocells with the need for the additional resource to support the particular traffic. The Femtocells that share resources with other Femtocells in the Femtocell network is rewarded with credits. The particular traffic is redirected to the Femtocells with excess resources and distributed to destinations.

### CROSS-REFERENCE TO RELATED APPLICATIONS/INCORPORATION BY REFERENCE

Not Applicable

### FIELD OF THE INVENTION

Certain embodiments of the invention relate to communication systems. More specifically, certain embodiments of the invention relate to a method and system for joint resource management in a Femtocell network.

### BACKGROUND OF THE INVENTION

The adoptions of wireless networks such as 3GPP, 3GPP2, and WiMAX have been accelerating over the past few years. Various wireless services have been provided via the wireless networks to enable consumers to experience excellent voice quality and a wide array of compelling data services. At the same time, residential broadband-access penetration has been rising quickly with the proliferation of DSL and cable modems, and as a result, fixed-mobile convergence (FMC) is gaining momentum in the marketplace.

The development of Femtocells aims to combine fixed-line broadband access with wireless telephony to extend carriers' wireless networks directly into the homes. A Femtocell is a very small wireless access device residing in a consumer's home. Femtocells leverage the existing Internet Protocol (IP) broadband links (such as DSL or cable) to backhaul various mobile services such as, for example, voice, video, SMS, and data traffic, from the home. Femtocells are designed to integrate with an existing wireless network and to work seamlessly with existing wireless handsets. Femtocells provide excellent coverage in indoor environments and enables operators to address new markets.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for joint resource management in a Femtocell network, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating an exemplary Femtocell network that enables a joint resource management among Femtocells, in accordance with an embodiment of the invention.

FIG. 2 is a diagram illustrating an exemplary Femtocell that is enabled to receive services via a joint resource management among Femtocells in a Femtocell network, in accordance with an embodiment of the invention.

FIG. 3 is a diagram illustrating an exemplary Femtocell gateway that is enabled to jointly manage resources among Femtocells in a Femtocell network, in accordance with an embodiment of the invention.

FIG. 4 is a flow chart illustrating an exemplary joint resource management procedure to share resources among Femtocells in a Femtocell network, in accordance with an embodiment of the invention.

FIG. 5 is a flow chart illustrating an exemplary joint resource management procedure to distribute traffic among Femtocells in a Femtocell network, in accordance with an embodiment of the invention.

FIG. 6 is a flow chart illustrating an exemplary credit-based billing procedure in a Femtocell network, in accordance with an embodiment of the invention.

### DETAILED DESCRIPTION OF THE INVENTION

Certain embodiments of the invention may be found in a method and system for a joint resource management in a Femtocell network. In accordance with various embodiments of the invention, a Femtocell gateway may be enabled to evaluate and determine resource usage information among a plurality of Femtocells in a Femtocell network. The Femtocell gateway may be configured to balance resource allocation and/or reallocation and allocate resources to distribute traffic among the associated Femtocells in the Femtocell network based on the determined resource usage information. The resource usage information may comprise IP usage information in a broadband IP network, radio access usage in a local radio access network, and/or physical layer capabilities among the Femtocells in the Femtocell network. Based on the determined resource usage information, the Femtocell gateway may be enabled to identify Femtocells with excess resources assigned and Femtocells with a need for additional resources to support, for example, a particular traffic. The Femtocell gateway may be enabled to apportion, reapportion, allocate and/or reallocate at least a portion of excess resources to the Femtocells with the need for the additional resource to support the particular traffic.

The Femtocells that share resources with other Femtocells in the Femtocell network may be rewarded with credits. The Femtocells that acquire additional resources from other Femtocells in the Femtocell network may have credit deduction. The credit information associated with each Femtocell in the Femtocell network may be communicated with a supporting carrier core network. The supporting carrier core network may utilize the credit information for billing and/or may generate billing corresponding Femtocells. In addition, the Femtocell gateway may be enabled to redirect the particular traffic from the Femtocells requiring additional resources to the Femtocells with excess resources. The particular traffic may be distributed via the Femtocells with excess resources to deliver to destinations. In various embodiments of the invention, new resources may be allocated and existing resources may be reallocated.

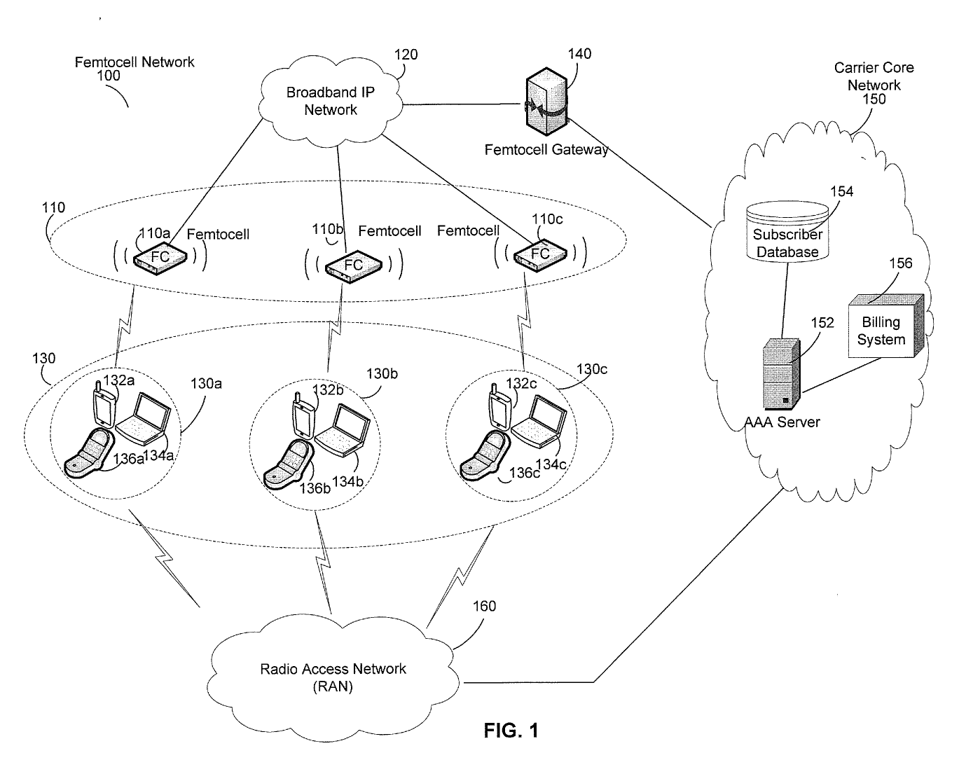

FIG. 1 is a diagram illustrating an exemplary Femtocell network that enables a joint resource management among Femtocells, in accordance with an embodiment of the invention. Referring to FIG. 1, there is shown a Femtocell network 100 comprising a plurality of Femtocells 110a, 110b, and 110c, which are collectively referred to herein as Femtocells 110, a broadband IP network 120, a plurality handsets 132a˜136a, 132b˜136b, and 132c˜136c, which are collectively referred to herein as handsets 130, a Femtocell gateway (FGW) 140, a carrier core network 150, and a radio access network (RAN) 160. The carrier core network 150 comprises an Authentication, Authorization and Accounting (AAA) server 152, a subscriber database 154, and a billing system 156, respectively.

The Femtocells 110 may comprise suitable logic, circuitry, and/or code that may be operable to communicate wirelessly with the plurality of handsets 120 utilizing an air interface protocol utilized by the RAN 160. The air interface may comprise one or more industry telecommunication standards such as 3GPP, 3GPP2, WiMAX, extensions thereto, and/or variants thereof. The Femtocells 110 may be referred to low power base station (BS) transceivers and may be located in a fixed structure such as a home or an office building. The Femtocells 110 may be enabled to provide radio access network (RAN) connectivity for the plurality of handsets 120. The Femtocells 110 may be connected to the carrier core network 150 using existing broadband connections such as, for example, cable, DSL, and/or on-premise fiber optic link, over the broadband IP network 120. The Femtocells 110 may enable indoor coverage for mobile communications truly pervasive while delivering additional benefits to both the mobile operators and end-users. The service area of the Femtocells 110 may comprise an indoor portion of a building as well as an outdoor portion of a building or campus. The building or campus may comprise commercial properties, residential properties, and/or multi-tenant properties.

The Femtocells 110 may be enabled to duplicate the functionality of a macro base station used in the RAN 160. For example, the Femtocells 110 may be configured to establish connections and associated sessions with served handsets using an air interface specified in, for example, 3GPP, 3GPP2, and/or WiMAX. The Femtocells 110 may be enabled to manage air-interface resources in an associated service area, perform scheduling, and/or maintaining various established connections.

The Femtocells 110 may be integrated, via the broadband IP network 120 and the Femtocell gateway 140, to the existing mobile core network such as the carrier core network 150 to work seamlessly with existing technology specific handsets. The existing handsets may be, for example, 3GPP-based handsets, 3GPP2-based handsets, and/or WiMAX-based handsets. In various embodiments of the invention, point-to-point and/or point-to-multipoint communications may be supported by the Femtocells 110. Each Femtocell such as the Femtocell 110a may be configured to serve a plurality of handsets such as the handsets 130a. The handsets 132a through 136a, 132b through 136b, and 132c through 136c may be associated with the Femtocells 110a, 110b, and 110c, respectively. A Femtocell together with the associated served handsets may form a Femto cell. Each of the Femtocells 110 may be enabled to manage communication of content provided by the carrier core network 150 with associated handsets. In this regard, resource usage information at each of the Femtocells 110 may be evaluated. Exemplary resources may comprise IP resource for example bandwidth, within the broadband IP network 120, radio access resources within the RAN 160, and/or physical layer capabilities. In instances where a Femtocell such as the Femtocell 110a may have excess resources, the excess resources may be made available to other Femtocells such as the Femtocell 110c requiring additional resources in order to support a desired service provided by the carrier core network 150. The Femtocell 110a sharing its radio access resources may be given credit for services provided by the carrier core network 150. For example, the given credit may vary depending on, for example, the amount of resources shared and/or a time such as peak or off peak hours when the resources are shared. In addition, traffic may be distributed among the Femtocells 110 based on the corresponding evaluated resource usage information.

The plurality of handsets 130 may comprise suitable logic circuitry and/or code that may be enabled to communicate radio frequency signals with various Femtocells such as the Femtocells 110 and the RAN 160. The plurality of handsets 130 may be enabled to access the carrier core network 150 and/or to other communication networks via the RAN 160 and/or the Femtocells 110. In this regard, in instances that a reliable session may be established between the carrier core network 150 and the handset 132b via a Femtocell such as the Femtocell 110a, the data may be communicated between the handset 132b and the carrier core network 150 via the Femtocell 110a. Alternatively, in instances that a reliable session may be established between the carrier core network 150 and the handset 132b via the RAN 160, the data may be communicated between the handset 132b and the carrier core network 150 via the RAN 160. An air interface protocol utilized by the RAN 160 may be utilized by the plurality of handsets 120 for communicating with the carrier core network 150 via the Femtocells 110 and/or the RAN 160.

The RAN 160 may comprise suitable logic circuitry and/or code that may enable communication of content associated with various services using radio access technology The RAN 160 may be enabled to deliver a variety of services to users over licensed spectrums such as, for example, 850 MHz and/or 1900 MHz licensed band for UMTS. The RAN 160 may be operable to access the carrier core network 150 to enable communications between the carrier core network 150 and the associated plurality of handsets 130. The RAN 160 may comprise geographically dispersed base stations and radio network controllers (RNC). An air interface protocol utilized by the RAN 160 may be utilized for various communications in the radio-frequency (RF) portion of the transmission path between the associated handsets 130 and active base stations within the RAN 160. In this regard, once being authorized, the associated handsets 130 may be configured to access the carrier core network 150 via the Femtocells 110 using the air interface protocol utilized by the RAN 160 as described by, for example, 3GPP, 3GPP2, or WiMAX standards.

The broadband IP network 120 may comprise suitable logic circuitry and/or code that may enable distribution of content associated with various services using Internet protocols (IP). The broadband IP network 120 may be operable to deliver a variety of services over broadband to users efficiently and cost-effectively. The broadband IP network 120 may be enabled to access to the Internet and/or one or more carrier core networks such as the carrier core network 150. The broadband IP network 120 may provide broadband IP connections to enable the Femtocells 110 to communicate various IP traffic with, for example, the PSTN and/or other wired or wireless devices, via the carrier core network 150. The broadband IP connections may comprise, for example, a digital subscriber line (DSL), a T1/E1 line, the cable television infrastructure, the satellite television infrastructure, and/or a satellite broadband Internet connection. The IP traffic over the broadband IP connections may be communicated with the carrier core network 150 via the FGW 140.

The FGW 140 may comprise suitable logic circuitry and/or code that may enable protecting the integrity of operators' core networks such as the carrier core network 150 from the public environment of the Internet, protecting the integrity of users' traffic, and supporting seamless transitions between the carrier core network 150 and Femtocell networks. The FGW 140 may communicatively couple various Femtocells such as the Femtocells 110 to the carrier core network 150. The FGW 140 may be configured to communicate with the carrier core network 150 using a radio network controller interface utilized by the RAN 160. For example, for UMTS-based Femtocells, the FGW 140 may apply a UTRAN Iu-cs interface for circuit switched voice services and a UTRAN Iu-ps interface for packet data services such as GPRS. In this manner, the FGW 140 may appear to a UTRAN core network as a traditional UTRAN network element such as, for example, a radio network controller (RNC) and may be managed and operated as such. In this regard, the FGW 140 may be enabled to evaluate resource usage information at each of the associated Femtocell. The resource usage information may comprise IP resource bandwidth, radio access resource bandwidth, and/or physical layer capabilities. The evaluated resource usage information may be utilized to determine availability and/or utilization of existing resources in the Femtocell network 100. The FGW 140 may be enabled to manage traffic distributed among the Femtocells 110 based on the evaluation. In instances that a Femtocell in the network may have excess resources, the FGW 140 may be operable to apportion, reapportion, allocate, and/or reallocate these excess resources to other Femtocells requiring additional resources. The Femtocells sharing their resources may be given credits based on amount of resources which they share, for example.

The carrier core network 150 may comprise suitable logic circuitry and/or code that may enable providing reliable transfer of information and connections between exemplary entities comprising content providers, service providers and access networks. The carrier core network 150 may provide various network related control functions for addressing, establishing, and releasing of connections and network management functions. The network management functions may comprise various signaling for network configurations, performance and fault monitoring, billing and accounting purposes via various core network components such as the AAA server 142, a subscriber database 144, and a billing system 146.

The AAA server 142 may comprise suitable logic circuitry and/or code that may be enabled to handle access control to the carrier core network 150. The AAA server 142 may be enabled to provide authentication, authorization, and accounting (AAA) services. The AAA server 142 may be configured to interact with the subscriber database 154 and with various core network gateways such as the Femtocell gateway 140 to identify users and implement policies for access troll. The subscriber database 154 may comprise suitable logic circuitry and/or code that may enable storage of the primary subscriber information such as subscribers' identities, and associating additional information (attributes) required to authenticate access requests to the carrier core network 150.

The subscriber database 154 may comprise security policies used to authorize those access requests authenticated to the carrier core network 150. The AAA server 142 may be enabled to communicate with the billing system 156 to keep track of time and data resources used for billing and analysis. The billing system 156 may comprise suitable logic circuitry and/or code that may be enabled to provide an administrator with the ability to monitor call logs, live data, and/or pending calls. The billing system 156 may be configured to track time and billing packets from the AAA server 142 to create a bill to be sent to a customer. The billing system 156 may allow a service provider to define policies for configuring various processes of a billing system based on charging and pricing schemes used for individual services discounts. In this regard, the billing system 156 may be enabled to define a billing policy such as flat fee and/or a reduced rate based on resource sharing credit information provided by the AAA server 152 and generate a bill using the defined billing policy for a corresponding Femtocell.

In operation, handsets served in the RAN 160, for example, the handset 130 may be enabled to request access to the carrier core network 150 via the Femtocells 110. The handsets 130 may communicate with the Femtocells 110 using an air interface protocol utilized in the RAN 160. Each of the handsets 130 may be associated with a particular Femtocell. For example, the handsets 130a may be associated with the Femtocell 110a. The handsets 130 may be configured to communicate with the carrier core network 150 via the Femtocell gateway 140 over the broadband IP network 120. The Femtocell gateway 140 may be enabled to evaluate resource usage information at each of the associated Femtocell. The resource usage information may comprise IP resource bandwidth, radio access resource bandwidth, and/or physical layer capabilities. The Femtocell gateway 140 may be enabled to determine availability and/or utilization of existing resources so as to distribute traffic in the Femtocell network 100 based on the evaluated resource usage information. The FGW 140 may manage and share resources among the Femtocells 110 within the Femtocell network 100. For example, the FGW 140 may allocate and/or reallocate excess resources assigned to one Femtocell such as the Femtocell 110a to other Femtocells such as the Femtocell 130c requiring additional resources. Moreover, the FGW 140 may give credit to the Femtocell 110a for resource sharing. The resource sharing information may be communicated with the AAA server 152 to be implemented into billing policies for the Femtocell 110a.

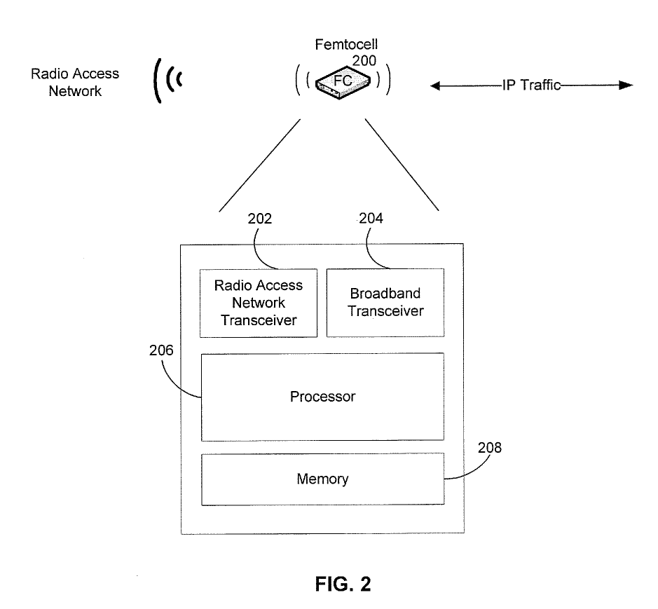

FIG. 2 is a diagram illustrating an exemplary Femtocell device that is enabled to receive services via a joint resource management among Femtocells in a Femtocell network, in accordance with an embodiment of the invention. Referring to FIG. 2, there is shown an exemplary Femtocell 200 comprising a radio access network transceiver 202, a broadband transceiver 204, a processor 206, and a memory 208.

The radio access network transceiver (RANT) 202 comprises suitable logic, circuitry and/or code that may be enabled to receive and/or transmit radio frequency signals from and/or to the handsets 130 over a radio access network such as, for example, UMTS, GSM, LTE, WiMAX, or other wireless network. The RANT transceivers 202 may be enabled to transmit and/or receive radio frequency (RF) signals, which may be communicated from/to the processor 204, using an air interface protocol utilized by the radio access network 160.

The broadband transceiver 204 may comprise suitable logic, circuitry, and/or code that may be operable to transmit voice and/or data in adherence with one or more internet protocol (IP) broadband standard. The broadband transceiver 204 may be enabled to transmit and/or receive voice and/or data to and/or from the broadband IP network 130 over a T1/E1 line, DSL, cable television infrastructure, satellite broadband Internet connection, satellite television infrastructure, and/or Ethernet.

The processor 206 may comprise suitable logic, circuitry and/or code that may be enabled to perform a variety of signal processing tasks and may comprise controlling of the RANT 202 as well as the broadband transceiver 204, for example. The processor 206 may be enabled to process various voice and/or data received via the broadband transceiver 204. In this regard, resources such as radio access resource, IP resource, and/or physical capability resource may be communicated with the FGW 140 to be used for jointly managing resources among the Femtocells 110.

The memory 208 may comprise suitable logic, circuitry and/or code that may enable storage of data and/or other information utilized by the processor 206. For example, the memory 208 may be utilized to store processed data generated by the processor 206. The memory 208 may be enabled to store executable instructions to process, for example, received content via the broadband IP transceiver 204. The memory 208 may enable storage of user profiles pertaining to the Femtocell 200. The user profiles may comprise a set of user specific parameters such as, for example, user identity, QoS capability, security profiles, and/or subscriber device configuration information. The memory 208 may comprise RAM, ROM, low latency nonvolatile memory such as flash memory and/or other suitable electronic data storage capable of storing data and instructions.

In operation, content associated with a particular service may be received via the broadband transceiver 204. The received content may be communicated with the processor 206 for further processing. The processor 206 may be enabled to identify one or more target handsets for the received content and communicate with the identified one or more target handsets via the RANTT 202. The process 206 may be enabled to utilize an air interface protocol for the communication of the received content with the identified one or more target handsets via the RANT 202. The air interface protocol is utilized by the RAN 160. Various algorithms stored in the memory 208 may be utilized for processing the received contents by the processor 206 to deliver to the identified one or more target handsets via the RANT 202. Various resource usages such as, for example, IP resource usage, radio access resource usage, and/or physical layer capability, may be communicated via the processor 206 with the FGW 140 to support joint resource management in the Femtocell network 100.

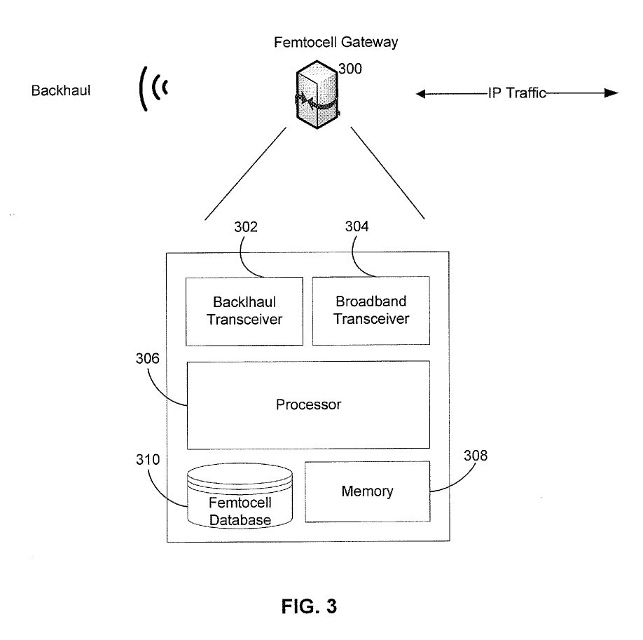

FIG. 3 is a diagram illustrating an exemplary Femtocell gateway that is enabled to jointly manage resources among Femtocells in a Femtocell network, in accordance with an embodiment of the invention. Referring to FIG. 3, there is shown an exemplary Femtocell gateway 300 comprising a backhaul transceiver 302, a broadband transceiver 304, a processor 306, a Femtocell database 308, and a memory 310.

The backhaul transceiver (BT) 302 comprises suitable logic, circuitry and/or code that may be enabled to receive and/or transmit radio frequency signals from and/or to the Femtocells 110 over a backhaul network. The backhaul network refers to the part of a mobile network that connects base stations to network controllers within a coverage area. The backhaul transceiver 302 may be enabled to communicate with the carrier core network 150 following specific sets of requirements required by the RAN 160.

The broadband transceiver 304 may comprise suitable logic, circuitry, and/or code that may be operable to transmit voice and/or data in adherence to one or more internet protocol (IP) broadband standard. The broadband transceiver 304 may be enabled to transmit and/or receive voice and/or data to and/or from the broadband IP network 130 over a T1/E1 line, DSL, cable television infrastructure, satellite broadband internet connection, satellite television infrastructure, and/or Ethernet.

The processor 306 may comprise suitable logic, circuitry and/or code that may be enabled to perform a variety of signal processing tasks and may comprise controlling of the backhaul transceiver 302 as well as the broadband transceiver 204, for example. The processor 306 may be enabled to process various voice, video, text, images, and/or data received via the backhaul transceiver 302 and communicate with one or more target handsets via the broadband transceiver 304 over the broadband IP network 120. In this regard, the processor 306 may be enabled to determine availability and/or utilization of resources in the Femtocell network 100. The processor 306 may be configured to evaluate resource usages at associated Femtocells to distribute traffic amongst the associated Femtocells in the Femtocell network 100. The processor 306 may be enabled to manage various resources IP bandwidth, cellular bandwidth, and physical layer capabilities jointly among the Femtocells 100. In instances where a Femtocell in the Femtocell network 100 may have excess resources, the processor 306 may be enabled to allocate and/or reallocate these excess resources to other Femtocells requiring additional resources. The processor 306 may give credits to the Femtocells sharing their resources. The processor 306 may assign the credits based on an amount of resources that are shared. Alternatively, the processor 306 may deduct credits from the Femtocells acquiring additional resources from other Femtocells. The processor 306 may deduct the credits based on amount of resources acquired.

The Femtocell database 308 may comprise suitable logic, circuitry and/or code that may enable storage of Femtocell profiles pertaining to the Femtocell gateway 140. The Femtocell database 308 may comprise Femtocell profiles associated with the Femtocell gateway 140. Each Femtocell has an associated Femtocell profile. The Femtocell profile may comprise Femtocell identity, Femtocell IP usage, Femtocell radio access usage, Femtocell physical layer capabilities, Femtocell security capabilities, and/or Femtocell device configuration information. The Femtocell database 308 may be stored in RAM, ROM, low latency nonvolatile memory such as flash memory and/or other suitable electronic data storage capable of storing data and instructions.

The memory 310 may comprise suitable logic, circuitry and/or code that may enable storage of data and/or other information utilized by the processor 306. For example, the memory 308 may be utilized to store processed data generated by the processor 306. The memory 308 may be enabled to store executable instructions to process, for example, Femtocell resource usage information to jointly manage resource allocation and/or reallocation among the Femtocells 110 within the Femtocell network 100. The memory 308 may comprise RAM, ROM, low latency nonvolatile memory such as flash memory and/or other suitable electronic data storage capable of storing data and instructions.

In operation, the Femtocell gateway 300 may be configured to communicate with the carrier core network 150 via the backhaul transceiver 302 and with the broadband IP network 120 via the broadband transceiver 304, respectively. The processor 306 may be enabled to process various voice, video, images and/or data received via the backhaul transceiver 302 or via the broadband transceiver 304. The processor 306 may be configured to manage resources jointly among the Femtocells 110. The resource usage information stored in the Femtocell database 308 may be used to determine availability and/or utilization of resources to support the various voice, video, images and/or data received in the Femtocell network 100. The processor 306 may be enabled to distribute traffic in the Femtocell 100 using various algorithms stored in the memory 310. Moreover, the processor 306 may balance resources among the Femtocells 110 by locating excess resources from one Femtocell to other Femtocells requiring additional resources. A Femtocell that shares its resources may be given credit based on the amount of resources shared.

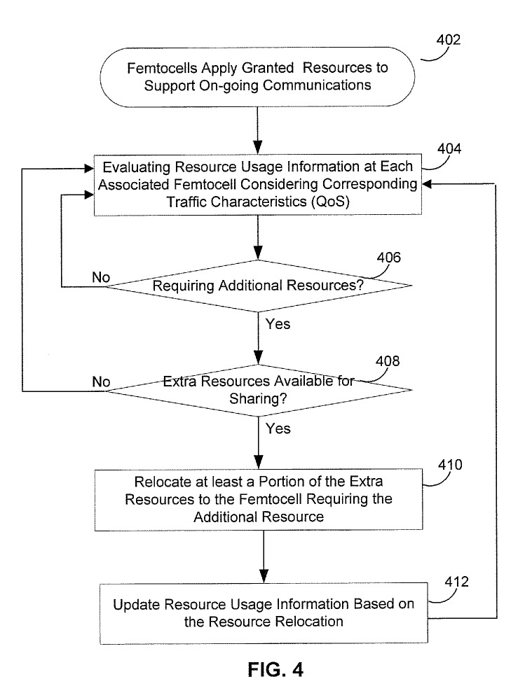

FIG. 4 is a flow chart illustrating an exemplary joint resource management procedure to share resources among Femtocells in a Femtocell network, in accordance with an embodiment of the invention. Referring to FIG. 4, the exemplary steps start with the step 402, where one or more Femtocells in the Femtocell network 100 may apply granted resources to support on-going communications between the handsets 130 and the carrier core network 150. In step 404, the FWG 140 may be enabled to evaluate resource usage information at each associated Femtocell by considering corresponding traffic characteristics (QoS). The resource usage information may comprise IP bandwidth usage, radio access bandwidth usage, and/or physical layer capabilities of associated Femtocells. The FWG 140 may consider corresponding traffic characteristics such as, for example, QoS associated with the traffic, to determine availability and/or utilization of resources to support the on-going traffic within the Femtocell network 100. In step 406, the FWG 140 may determine whether an associated Femtocell may require additional resources.

In instances where an associated Femtocell in the Femtocell network 100 may require additional resources, whether additional IP bandwidth, additional access bandwidth, and/or additional physical layer capabilities, to continue corresponding services, then in step 408, the FWG 140 may determine if there may be extra resources among the associated Femtocells available to be shared. In instances where the FWG 140 may identify one or more Femtocells in the Femtocell network 100 that may have excess resources to be shared with other associated Femtocells in the Femtocell network 100, then in step 410, the FWG 140 may be enabled to allocate and/or reallocate at least a portion of the extra resources to the Femtocell requiring the additional resource. Amount of the excess resources allocated and/or reallocated is determined based on the need.

In step 412, the FWG 140 may be enabled to update resource usage information for each associated Femtocell in the Femtocell network based on the resource Relocation. The updated resource usage information may be stored in the Femtocell database 308. In step 406, in instances where no associated Femtocell in the Femtocell network 100 may require additional resources, then the exemplary steps return to step 404. In step 408, in instances where the FWG 140 may not identify a Femtocell in the Femtocell network 100 may have excess resources to be shared with other associated Femtocells in the Femtocell network 100, then the exemplary steps return to step 404.

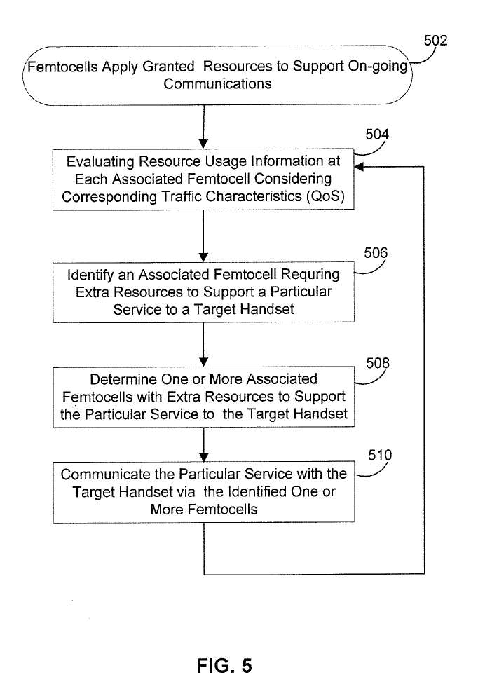

FIG. 5 is a flow chart illustrating an exemplary joint resource management procedure to distribute traffic among Femtocells in a Femtocell network, in accordance with an embodiment of the invention. Referring to FIG. 5, the exemplary steps start with the step 502, where one or more Femtocells in the Femtocell network 100 may apply granted resources to support on-going communications between the handsets 130 and the carrier core network 150. In step 504, the FWG 140 may be enabled to evaluate resource usage information at each associated Femtocell by considering corresponding traffic characteristics (QoS). The resource usage information may comprise IP bandwidth usage, radio access bandwidth usage, and/or physical layer capabilities of associated Femtocells. The FWG 140 may consider corresponding traffic characteristics such as, for example, QoS associated with the traffic, to determine availability and/or utilization of resources to support the on-going traffic within the Femtocell network 100.

In step 506, the FWG 140 may be enabled to identify an associated Femtocell such as the Femtocell 110a requiring extra resources in order to support a particular service to a target handset such as the handset 132b. In step 508, the FWG 140 may access the Femtocell database 308 for Femtocell usage information. The FWG 140 may be enabled to determine whether one or more associated Femtocells in the Femtocell network 100 may be operable to serve the target handset and the one or more Femtocells may also have extra resources to be used to support the particular service. In step 510, the FWG 140 may distribute traffic associated with the particular service to the determined one or more Femtocells and communicate it to the handset 132b. The exemplary steps return to step 504.

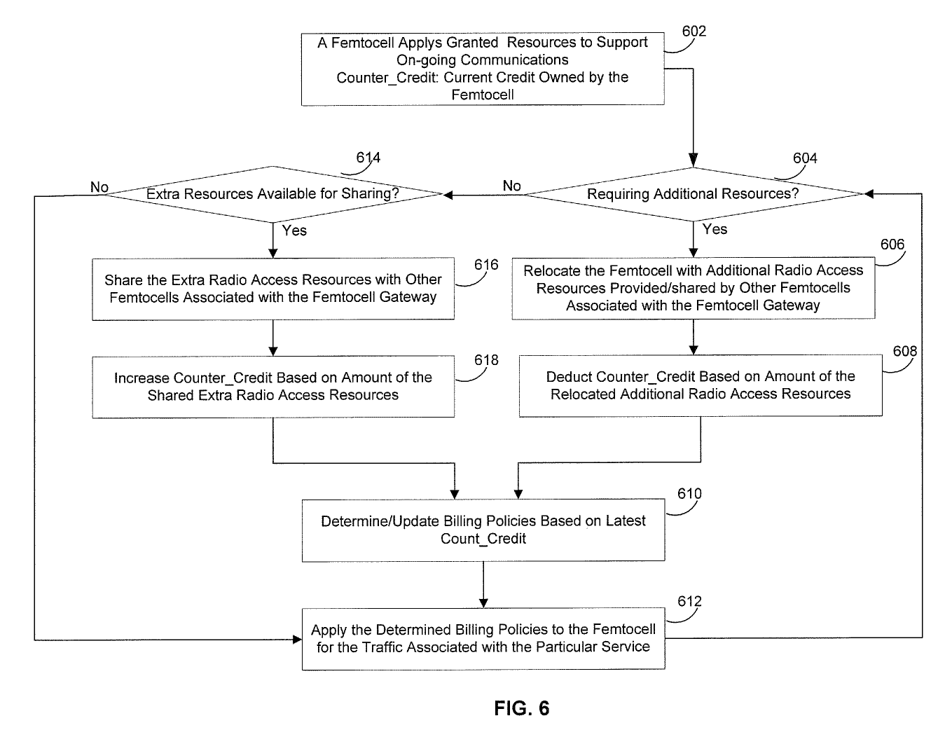

FIG. 6 is a flow chart illustrating an exemplary credit-based billing procedure in a Femtocell network, in accordance with an embodiment of the invention. Referring to FIG. 6, the exemplary steps start with the step 602, where a Femtocell such as the Femtocell 110a in the Femtocell network 100 may apply granted resources to support on-going communications between the handsets 130. The parameter Counter_Credit may indicate current credit owned by the Femtocell 110a. In step 604, the FWG 140 may determine whether the Femtocell 110a may require additional resources in order to support a particular service. In instances where the Femtocell 110a may require additional resources in order to support the particular service, then in step 606, the FWG 140 may be enabled to allocate and/or reallocate the Femtocell 110a with additional radio access resources that are provided or shared by other Femtocells associated with the Femtocell Gateway 140. In step 608, the FWG 140 may be configured to deduct Counter_Credit based on amount of the allocated and/or reallocated additional radio access resources. In step 610, the information of the latest credit associated with the Femtocell 110a may be communicated with the AAA server 152 in the carrier core network 150. The AAA server 152 may communicate with the billing system 156. The billing system 156 may then determine or update billing policies to the Femtocell 110 for the traffic associated with the particular service. The exemplary steps return to step 406. In step 604, in instances where the Femtocell 110a may not require additional resources, then in step 614, the FWG 140 may determine if the Femtocell 110a may have extra resources available for sharing with other Femtocells in the Femtocell network 100. In instances where the FWG 140 may determine that the Femtocell 110a may have extra resources available for sharing with other Femtocells in the Femtocell network 100, then in step 616, the FWG 140 may be enabled to use the additional radio access resources to share with other Femtocells in the Femtocell network 100. In step 618, the FWG 140 may be configured to increase Counter_Credit based on the amount of the shared extra radio access resources. The exemplary steps continue in step 610. In step 614, in instances where the FWG 140 may determine that the Femtocell 110a may have no extra resources available for sharing with other Femtocells in the Femtocell network 100, then the exemplary steps continue in step 612.

Aspects of a method and system for a joint resource management in a Femtocell network are provided. In accordance with various embodiments of the invention, referring to FIG. 1 through FIG. 6, the FWG 140 may be enabled to evaluate and determine resource usage information among a plurality of Femtocells such as the Femtocells 110 in the Femtocell network 100. The FWG 140 may be configured to balance resource allocation and/or reallocation and allocate resources to distribute traffic among the associated Femtocells in the Femtocell network 100 based on the determined resource usage information. The resource usage information may comprise IP usage information in the broadband IP network 120, radio access usage in the RAN 160, and/or physical layer capabilities among the Femtocells 110 in the Femtocell network 100. Based on the determined resource usage information, the FWG 140 may be enabled to identify Femtocells with excess resources assigned and Femtocells with a need for additional resources to support, for example, a particular traffic. As described with respect to, for example, FIG. 4, the FWG 140 may be enabled to allocate and/or reallocate at least a portion of excess resources to the Femtocells with the need for the additional resource to support the particular traffic. New resources may be allocated and existing resources may be reallocated. The Femtocells that share resources with other Femtocells in the Femtocell network 100 may be compensated with credits. For example, the credit compensation may comprise a reduction if usage cost. The Femtocell that acquires additional resources from other Femtocells in the Femtocell network may have deducted credit. The credit information associated with each Femtocell in the Femtocell network 100 may be communicated with the AAA server 152 in the carrier core network 150. The AAA server 152 may provide the credit information to the billing system 156. The billing system 156 may be enabled to utilize the credit information for billing or may generate billing policies for corresponding Femtocells in the Femtocell network 100. The FWG 140 may then receive accounting information from the carrier core network 150 for the corresponding Femtocells based on corresponding credit. In addition, the FWG 140 may be enabled to redirect the particular traffic from the Femtocells requiring additional resources to the Femtocells with excess resources. The particular traffic may be distributed via the Femtocells with excess resources to deliver to destinations, accordingly.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for a joint resource management in a Femtocell network.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
determining via a femtocell gateway, resource usage information among a plurality of Femtocells in a Femtocell network; and
allocating resources for distributing traffic among said plurality of Femtocells in said Femtocell network based on said determined resource usage information.

2. The method according to claim 1, wherein said resource usage information comprise IP bandwidth usage, radio access bandwidth usage, and/or physical layer capabilities among said plurality of Femtocells in said Femtocell network.

3. The method according to claim 1, comprising
identifying a first Femtocell based on said determined resource usage information, wherein said first Femtocell has excess resources to share in said Femtocell network; and
identifying a second Femtocell based on said determined resource usage information, wherein said second Femtocell requires additional resources from said Femtocell network to support a particular traffic.

4. The method according to claim 3, comprising allocating and/or reallocating at least a portion of said excess resources to said second Femtocell for said traffic.

5. The method according to claim 4, comprising rewarding credit to said first Femtocell based on said allocated and/or reallocated portion of said excess resources.

6. The method according to claim 5, comprising receiving accounting information for said first Femtocell based on said rewarded credit.

7. The method according to claim 4, comprising deducting credit to said second Femtocell based on said allocated and/or reallocated portion of said excess resources.

8. The method according to claim 7, comprising receiving accounting information for said second Femtocell based on said deducted credit.

9. The method according to claim 3, comprising allocating resources for distributing said particular traffic to said first Femtocell.

10. The method according to claim 1, wherein said Femtocell network supports 3GPP-based handsets, 3GPP2-based handsets, and/or WiMAX-based handsets.

11. A system for communication, the system comprising:
one or more circuits for use in a femtocell gateway, wherein said one or more circuits are operable to determine resource usage information among a plurality of Femtocells in a Femtocell network; and
said one or more circuits are operable to allocate resources for distributing traffic among said plurality of Femtocells in said Femtocell network based on said determined resource usage information.

12. The system according to claim 11, wherein said resource usage information comprise IP bandwidth usage, radio access bandwidth usage, and/or physical layer capabilities among said plurality of Femtocells in said Femtocell network.

13. The system according to claim 13, wherein
said one or more circuits are operable to identify a first Femtocell based on said determined resource usage information, wherein said first Femtocell has excess resources to share in said Femtocell network; and
said one or more circuits are operable to identify a second Femtocell based on said determined resource usage information, wherein said second Femtocell requires additional resources from said Femtocell network to support a particular traffic.

14. The system according to claim 13, wherein said one or more circuits are operable to allocate and/or reallocate a least a portion of said excess resources to said second Femtocell for said traffic.

15. The system according to claim 14, wherein said one or more circuits are operable to reward credit to said first Femtocell based on said allocated and/or reallocated portion of said excess resources.

16. The system according to claim 15, wherein said one or more circuits are operable to receive accounting information for said first Femtocell based on said rewarded credit.

17. The system according to claim 14, wherein said one or more circuits are operable to deduct credit to said second Femtocell based on said allocated and/or reallocated portion of said excess resources.

18. The system according to claim 17, wherein said one or more circuits are operable to receive accounting information for said second Femtocell based on said deducted credit.

19. The system according to claim 13, wherein said one or more circuits are operable to allocate resources for distributing said particular traffic to said first Femtocell.

20. The system according to claim 11, wherein said Femtocell network supports 3GPP-based handsets, 3GPP2-based handsets, and/or WiMAX-based handsets.
